(19) United States
(12) Patent Application Publication
(10) Pub. No.: US 2016/0266432 A1
(43) Pub. Date: Sep. 15, 2016

(54) LIQUID CRYSTAL DISPLAY DEVICE AND MANUFACTURING METHOD THEREOF

(71) Applicant: Mitsubishi Electric Corporation, Tokyo (JP)

(72) Inventor: Akira TAMATANI, Kumamoto (JP)

(73) Assignee: Mitsubishi Electric Corporation, Tokyo (JP)

(21) Appl. No.: 15/042,781

(22) Filed: Feb. 12, 2016

(30) Foreign Application Priority Data
Mar. 10, 2015 (JP) 2015-046697

(51) Int. Cl. G02F 1/1339; G02F 1/1341

(52) U.S. Cl. CPC G02F 1/13394; G02F 1/1339; G02F 1/1341; G02F 2001/13396; G02F 2001/13398; G02F 2001/13415

(57) ABSTRACT

A liquid crystal display device includes a TFT array substrate, a CF substrate arranged at the position opposite to the TFT array substrate via a liquid crystal layer, a sealing pattern that seals liquid crystal held between the TFT array substrate and the CF substrate, a bead-like spacer that is arranged in the sealing pattern and elastically deformable, and a columnar spacer arranged in the sealing pattern and formed to have a length shorter than the bead-like spacer in the thickness direction of the liquid crystal layer.

### BACKGROUND OF THE INVENTION

1. Field of the Invention

The present invention relates to a liquid crystal display device that can suppress occurrence of a display failure.

2. Description of the Background Art

A vacuum injection method and a one drop filling method (ODF) have popularly been employed as a manufacturing method of a liquid crystal display device. A manufacturing method of a liquid crystal display device will be described below, taking the one drop filling method as one example. An electrode substrate on which a TFT is formed and a counter substrate on which color filters and the like are formed for performing a color display are prepared. An orientation film is formed on each substrate, and an orientation process such as rubbing is performed.

In order to keep the space between two substrates constant, a bead-like spacer is dispersed in one of the substrates, or a substrate on which a columnar projection is preliminarily formed is used. A sealing pattern for bonding two substrates is formed on one of the substrates, and then, liquid crystal is dropped in a necessary quantity.

Spacers-in-sealing for keeping the space between sealing portions constant are mixed in the sealing pattern in a constant rate. The spacers-in-sealing are made of a rod-like glass (crushed materials of glass fiber) or particulate silica.

Then, the substrates are held on upper and lower surface plates in a vacuum chamber, and the two substrates are made close to each other and bonded to each other, while adjusting the positions of the substrates so as to align the patterns on the upper and lower substrates with each other. When the contact between the sealing pattern and the substrate is insufficient, and a gap is formed between the sealing pattern and the substrate, air bubbles might enter a panel, or the bonded substrates might be shifted when the substrate is separated from the upper surface plate. Therefore, a load is applied to allow the sealing pattern to be in close contact with each of the two substrates. Thereafter, the separation of the upper surface plate and release to the atmosphere are performed, and then, the substrates are extracted. The sealing pattern is crushed up to a predetermined width with pressure difference between the inside of the panel and surrounding portion (atmospheric pressure). Thereafter, the sealing pattern is temporarily cured with a UV irradiation device, and then, fully cured with a heat treatment. Then, predetermined processes are performed to complete a liquid crystal display device.

The surface plate of the bonding device is provided with a pin hole for the delivery with a robot and a recess for avoiding interference with a robot arm. Especially with the one drop filling method, an electrostatic chuck method is used for holding substrates during a vacuum bonding process. A lot of screw holes for mounting an electrostatic chuck unit to the surface plate are formed. When a load is applied to the surface plate for allowing the sealing pattern to be sufficiently in close contact with the two substrates, a large load is locally applied to the vicinity of the screw holes. When foreign matters are present between the surface plate and the substrate, a large load is locally applied in a similar way.

A problem arises when the place where a load is locally applied is a sealing portion. When the spacer-in-sealing is made of crushed materials of glass fiber, wiring lines of the TFT array substrate are damaged, since the crushed materials of glass fiber is hard. This might cause a problem of disconnection or short-circuiting.

In order to solve the above problem, a method of providing a bead-like spacer made of soft resin or a method (see Japanese Patent Application Laid-Open No. 2002-35784, for example) in which the spacer-in-sealing is eliminated and a projection is formed near the sealing pattern has been employed.

When a bead-like spacer made of resin is provided, the bead-like spacer is greatly deformed to narrow the space between the substrates. Therefore, a sealing pattern is excessively crushed, increasing the sealing width. When the load is removed after the bonding process, the bead-like spacer returns to its original shape, so that the sealing width also returns to its original width. In this case, air is caught up from the periphery, resulting in generating bubble-in-sealing which is air bubble formed in the sealing pattern. This deteriorates adhesive force and moisture resistance (environment resistance) of the sealing pattern to cause a display failure. With this, a problem of reduction in yield of the liquid crystal display device occurs.

With the method described in Japanese Patent Application Laid-Open No. 2002-357834, the sealing pattern is crushed, and the sealing width becomes too wide. This sealing pattern enters a display region to cause a display failure, or protrudes from the substrate to deteriorate yield of the liquid crystal display device.

Liquid crystal display devices with a variety of sizes from a compact type (several inches) to a large-sized type (tens of inches) have been produced, and a sealing pattern is formed on an optional place of a substrate. Therefore, it is difficult to avoid the above problem by devising a surface plate structure (such as a position of a screw hole).

### SUMMARY OF THE INVENTION

The present invention aims to provide a liquid crystal display device that can suppress an occurrence of a display failure to enhance yield, even if a load is locally applied upon bonding substrates to each other.

A liquid crystal display device according to the present invention includes: a first substrate; a second substrate arranged at the position opposite to the first substrate via a liquid crystal layer; a sealing pattern that seals liquid crystal held between the first and second substrates; a first spacer that is arranged in the sealing pattern and elastically deformable; and a second spacer arranged in the sealing pattern and formed to have a length shorter than the first spacer in the thickness direction of the liquid crystal layer.

The term “strength against deformation” used in the specification of the present application means “elastic constant (elastic modulus)” which is a physical property indicating a difficulty in deformation.

The liquid crystal display device includes: a first substrate; a second substrate arranged at the position opposite to the first substrate via a liquid crystal layer; a sealing pattern that seals liquid crystal held between the first and second substrates; a first spacer that is arranged in the sealing pattern and elastically deformable; and a second spacer arranged in the sealing pattern and formed to have a length shorter than the first spacer in the thickness direction of the liquid crystal layer.

With this configuration, when a load is locally applied upon bonding the first and second substrates to each other, the first spacer is elastically deformed. However, the load can be supported by the second spacer, whereby the distance between the first and second substrates can be maintained. Accordingly, the sealing pattern is not excessively crushed, which can prevent the generation of bubble-in-sealing and excessive increase in the width of the sealing pattern.

These and other objects, features, aspects and advantages of the present invention will become more apparent from the following detailed description of the present invention when taken in conjunction with the accompanying drawings.

### BRIEF DESCRIPTION OF THE DRAWINGS

FIGS. 1A, 1B, and 1C are views illustrating a configuration of a main part of a liquid crystal panel in a liquid crystal display device according to a preferred embodiment.

FIG. 2 is a plan view of the liquid crystal panel in the liquid crystal display device.

FIG. 3 is a sectional view taken along a line B-B in FIG. 2.

FIG. 4 is a flowchart illustrating a manufacturing process of the liquid crystal panel.

FIGS. 5A and 5B are views illustrating a configuration of a main part of a liquid crystal panel according to an underlying technology when a load is inputted.

FIGS. 6A and 6B are views illustrating the configuration of the main part of the liquid crystal panel according to the underlying technology when the load is removed.

FIG. 7 is a plan view illustrating a main part of a liquid crystal panel according to another example in the underlying technology when a load is inputted.

### DESCRIPTION OF THE PREFERRED EMBODIMENT

### Preferred Embodiment

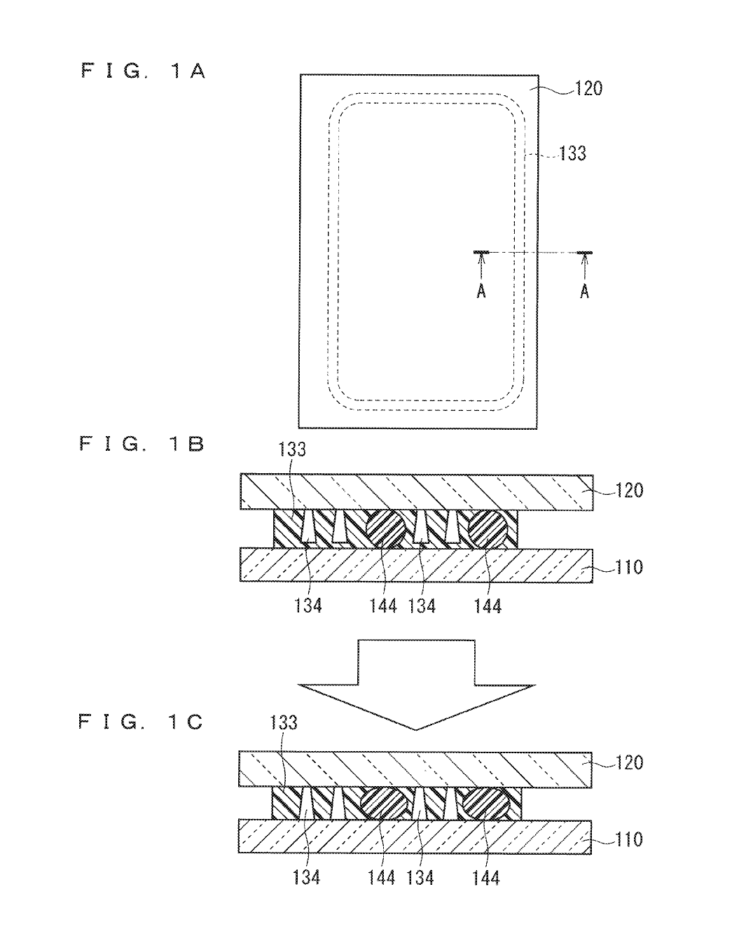

A preferred embodiment of the present invention will be described below with reference to the drawings. FIGS. 1A, 1B, and 1C are views illustrating a configuration of a main part of a liquid crystal panel in a liquid crystal display device according to the preferred embodiment, wherein FIG. 1A is a plan view illustrating the main part of the liquid crystal panel, FIG. 1B is a sectional view taken along a line A-A in FIG. 1A in a normal state, and FIG. 1C is a sectional view taken along the line A-A in FIG. 1A when a load is locally applied.

As illustrated in FIGS. 1A and 1B, the liquid crystal display panel composing the liquid crystal display device according to the preferred embodiment includes a TFT array substrate 110 serving as a first substrate, a color filter substrate (CF substrate) 120 serving as a second substrate, a sealing pattern 133, bead-like spacers 144 (first spacer), and columnar spacers 134 (second spacer). The TFT array substrate 110 is an array substrate on which switching elements such as TFT and pixel electrodes are disposed in an array. The CF substrate 120 has formed thereon color materials for performing a color display, and it is a counter substrate arranged at the position opposite to the TFT array substrate 110.

The sealing pattern 133 is a material for sealing liquid crystal held between the TFT array substrate 110 and the CF substrate 120. The bead-like spacers 144 are disposed in the sealing pattern 133, and made of elastically deformable resin. The columnar spacers 134 are disposed in the sealing pattern 133, and formed by patterning an organic resin film. Each of the columnar spacers 134 is disposed to project downward from the bottom surface of the CF substrate 120, has a higher strength against deformation than the bead-like spacer 144, and is formed to have a length shorter than the bead-like spacer 144 in the thickness direction of the liquid crystal. With this, in a normal state in which a load is not inputted as illustrated in FIG. 1B, the lower end of the columnar spacer 134 is not in contact with the TFT array substrate 110, so that a gap is formed between the lower end of the columnar spacer 134 and the TFT array substrate 110. The sealing pattern 133 is arranged in this gap. In this preferred embodiment, the columnar spacer 134 has the strength against deformation by which a predetermined load can be supported.

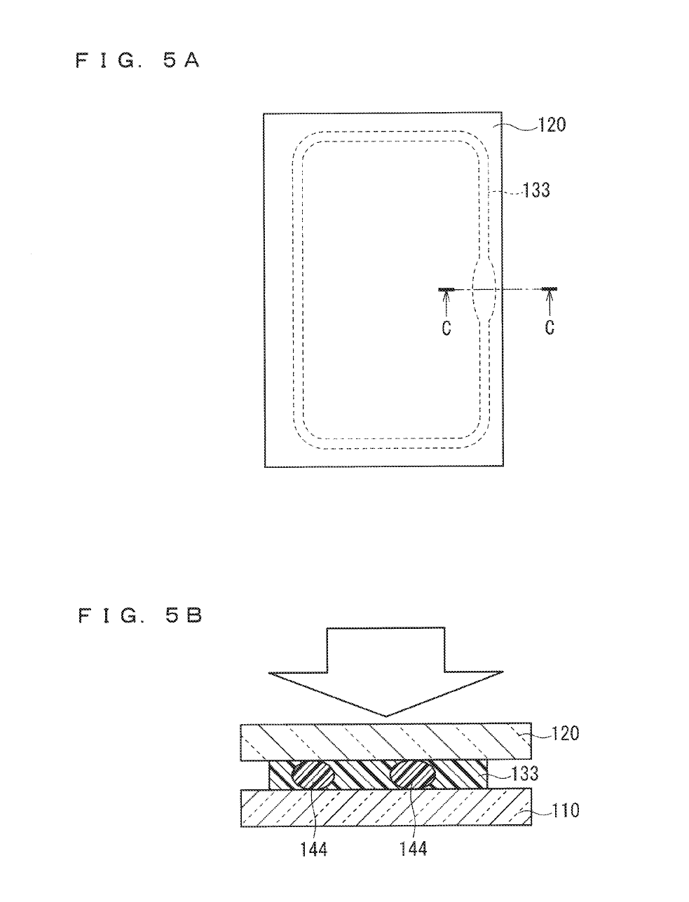

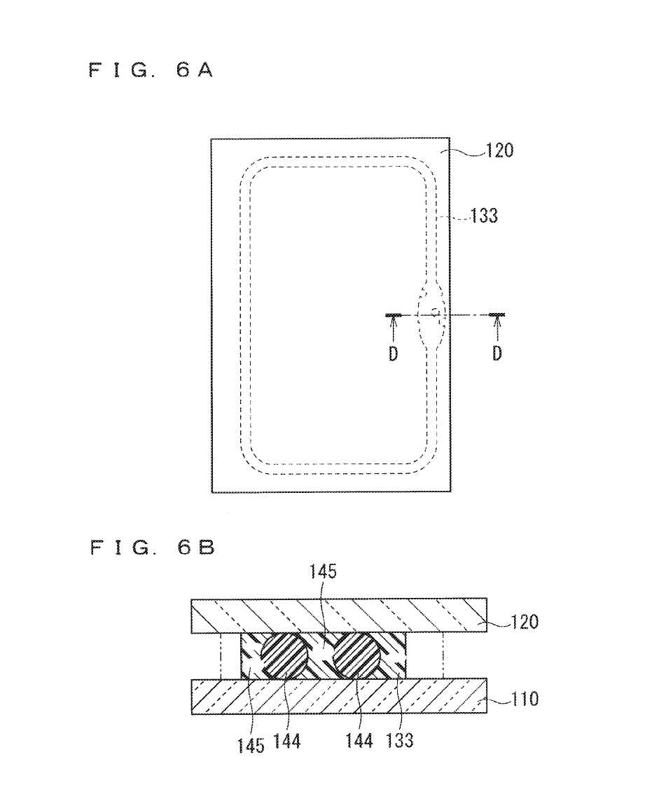

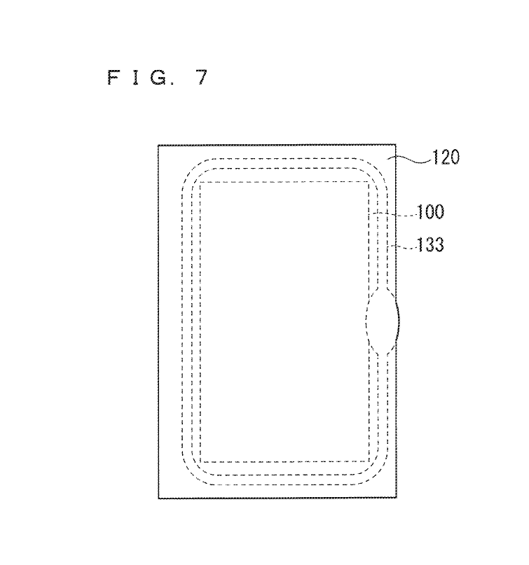

The problem of a liquid crystal display device according to the underlying technology will next be described. FIGS. 5A and 5B are views illustrating a configuration of a main part of a liquid crystal panel when a load is inputted in the underlying technology, wherein FIG. 5A is a plan view illustrating the main part of the liquid crystal panel when a load is inputted in the underlying technology, and FIG. 5B is a sectional view taken along a line C-C in FIG. 5A. FIGS. 6A and 6B are views illustrating a configuration of the main part of the liquid crystal panel when the load is removed in the underlying technology, wherein FIG. 6A is a plan view illustrating the main part of the liquid crystal panel after the load is removed in the underlying technology, and FIG. 6B is a sectional view taken along a line D-D in FIG. 6A. FIG. 7 is a plan view illustrating a main part of a liquid crystal panel according to another example in the underlying technology when a load is inputted.

As illustrated in FIGS. 5A and 5B, the liquid crystal panel composing the liquid crystal display device according to the underlying technology includes a TFT array substrate 110, a CF substrate 120, a sealing pattern 133, and bead-like spacers 144. When the substrates are bonded, a load is applied, which brings large elastic deformation of the bead-like spacers 144 to narrow the space between the substrates. Therefore, the sealing pattern 133 is excessively crushed, increasing the sealing width.

When the load is removed after the bonding of the substrates, the bead-like spacers 144 return to their original shape, so that the sealing width also returns to its original width (the sealing width returns to the position indicated by a solid line from the position indicated by a two-dot-chain line) as illustrated in FIGS. 6A and 6B. In this case, air is caught up from the periphery, resulting in that bubble-in-sealing (void-in-sealing) 145 is formed in the sealing pattern 133. This deteriorates adhesive force and moisture resistance (environment resistance) of the sealing pattern 133 to cause a display failure. With this, a problem of reduction in yield of the liquid crystal display device occurs.

As illustrated in FIG. 7, when the spacers-in-sealing are eliminated, and a projection is formed near the sealing pattern 133, the sealing pattern 133 is crushed, and the sealing width becomes too wide. This sealing pattern 133 enters the display region 100 to cause a display failure, or protrudes from the substrate to deteriorate yield of the liquid crystal display device.

On the other hand, in the liquid crystal display device according to the preferred embodiment, when a load that does not exceed the strength against deformation of the columnar spacer 134 is locally applied to the TFT array substrate 110 and the CF substrate 120, the bead-like spacers 144 are elastically deformed until the lower ends of the columnar spacers 134 are brought into contact with the TFT array substrate 110, as illustrated in FIG. 1C. However, the load can be supported by the columnar spacers 134, whereby the distance between the TFT array substrate 110 and the CF substrate 120 can be maintained. Accordingly, the sealing pattern 133 is not excessively crushed, which can prevent the generation of void-in-sealing and excessive increase in the width of the sealing pattern 133.

Next, experimental examples and comparative examples of the liquid crystal display device will be described.

### Experimental Example 1

A columnar spacer having a length of 3.1 micrometers was formed with a photolithography process (photolitho process) on a portion of a CF substrate where a sealing was to be formed. The spacer density (in terms of area) was set to be about 2%. The spacer density means an area density of the columnar spacer to an area of a sealing pattern in a plan view. A sealing pattern including 1 wt % of resinous bead-like spacer (SP-2035 manufactured by Sekisui Chemical Co. Ltd.) with a diameter of 3.5 micrometers was applied on a predetermined position of the CF substrate with a dispenser. Then, liquid crystal was dropped, and two substrates were bonded to each other in a vacuum. Predetermined processes were performed, whereby a liquid crystal display device was manufactured. The difference in length in the thickness direction of the liquid crystal between the bead-like spacer and the columnar spacer was 11.4% of the diameter of the bead-like spacer.

Even when a load is locally applied to the portion corresponding to the sealing pattern due to deposition of foreign matters or poor flatness of a stage, the deformation amount of the spacer-in-sealing is small, and the void-in-sealing is not generated, since the columnar spacer is formed on the portion corresponding to the sealing pattern. With this, the liquid crystal display device was able to be manufactured with excellent yield.

### Experimental Example 2

A columnar spacer having a length of 6.0 micrometer was formed with a photolitho process on a portion of a CF substrate where a sealing was to be formed. The spacer density (in terms of area) was set to be about 1%. A sealing pattern including 1 wt % of resinous bead-like spacer (SP-2065 manufactured by Sekisui Chemical Co. Ltd.) with a diameter of 6.5 micrometers was applied on a predetermined position of the CF substrate with a dispenser. Then, liquid crystal was dropped, and two substrates were bonded to each other in a vacuum. Predetermined processes were performed, whereby a liquid crystal display device was manufactured. The difference in length in the thickness direction of the liquid crystal between the bead-like spacer and the columnar spacer was 7.7% of the diameter of the bead-like spacer.

Even when a large load is locally applied to the portion corresponding to the sealing pattern, the deformation amount of the spacer-in-sealing is small, and the void-in-sealing is not generated, since the columnar spacer is formed on the portion corresponding to the sealing pattern. With this, the liquid crystal display device was able to be manufactured with excellent yield.

### Experimental Example 3

A columnar spacer having a length of 5.0 micrometer was formed with a photolitho process on a portion of a CF substrate where a sealing was to be formed. The spacer density (in terms of area) was set to be about 1%. A sealing pattern including 1 wt % of resinous bead-like spacer (SP-2065 manufactured by Sekisui Chemical Co. Ltd.) with a diameter of 6.5 micrometers was applied on a predetermined position of the CF substrate with a dispenser. Then, liquid crystal was dropped, and two substrates were bonded to each other in a vacuum. Predetermined processes were performed, whereby a liquid crystal display device was manufactured. The difference in length in the thickness direction of the liquid crystal between the bead-like spacer and the columnar spacer was 23.1% of the diameter of the bead-like spacer.

Even when a large load is locally applied to the portion corresponding to the sealing pattern, the deformation amount of the spacer-in-sealing is small, and the void-in-sealing is not generated, since the columnar spacer is formed on the portion corresponding to the sealing pattern. With this, the liquid crystal display device was able to be manufactured with excellent yield.

### Experimental Example 4

A columnar spacer having a length of 3.0 micrometer was formed with a photolitho process on a portion of a CF substrate where a sealing was to be formed. The spacer density (in terms of area) was set to be about 1%. A sealing pattern including 1 wt % of resinous bead-like spacer (SP-2065 manufactured by Sekisui Chemical Co. Ltd.) with a diameter of 6.5 micrometers was applied on a predetermined position of the CF substrate with a dispenser. Then, liquid crystal was dropped, and two substrates were bonded to each other in a vacuum. Predetermined processes were performed, whereby a liquid crystal display device was manufactured. The difference in length in the thickness direction of the liquid crystal between the bead-like spacer and the columnar spacer was 53.8% of the diameter of the bead-like spacer.

In this case, a generation ratio of void-in-sealing increased compared to the experimental examples 1 to 3, so that a manufacturing yield of the liquid crystal display device was deteriorated.

### Experimental Example 5

A columnar spacer having a length of 3.1 micrometer was formed with a photolitho process on a portion of a CF substrate where a sealing was to be formed. The spacer density (in terms of area) was set to be about 0.2%. A sealing pattern including 1 wt % of resinous bead-like spacer (SP-2035 manufactured by Sekisui Chemical Co. Ltd.) with a diameter of 3.5 micrometers was applied on a predetermined position of the CF substrate with a dispenser. Then, liquid crystal was dropped, and two substrates were bonded to each other in a vacuum. Predetermined processes were performed, whereby a liquid crystal display device was manufactured. The difference in length in the thickness direction of the liquid crystal between the bead-like spacer and the columnar spacer was 11.4% of the diameter of the bead-like spacer.

In this case, a generation ratio of void-in-sealing increased compared to the experimental examples 1 to 3, so that a manufacturing yield of the liquid crystal display device was deteriorated.

From the above, it is preferable that the spacer density (in terms of area) is set to be equal to or larger than 1% from the viewpoint of strength of the columnar spacer. It is also preferable that the realistic upper limit of the spacer density (in terms of area) is set to be less than 50% from the viewpoint of interference with the bead-like spacer. A liquid crystal display device was able to be manufactured with excellent yield with the configuration in which the difference in length in the thickness direction of the liquid crystal between the bead-like spacer and the columnar spacer was 23.1% (experimental example 3). However, it is preferable that the difference is set to be equal to or lower than 15% in order to further decrease the deformation amount of the spacer-in-sealing to further suppress the generation of void-in-sealing.

(Configuration of Liquid Crystal Panel)

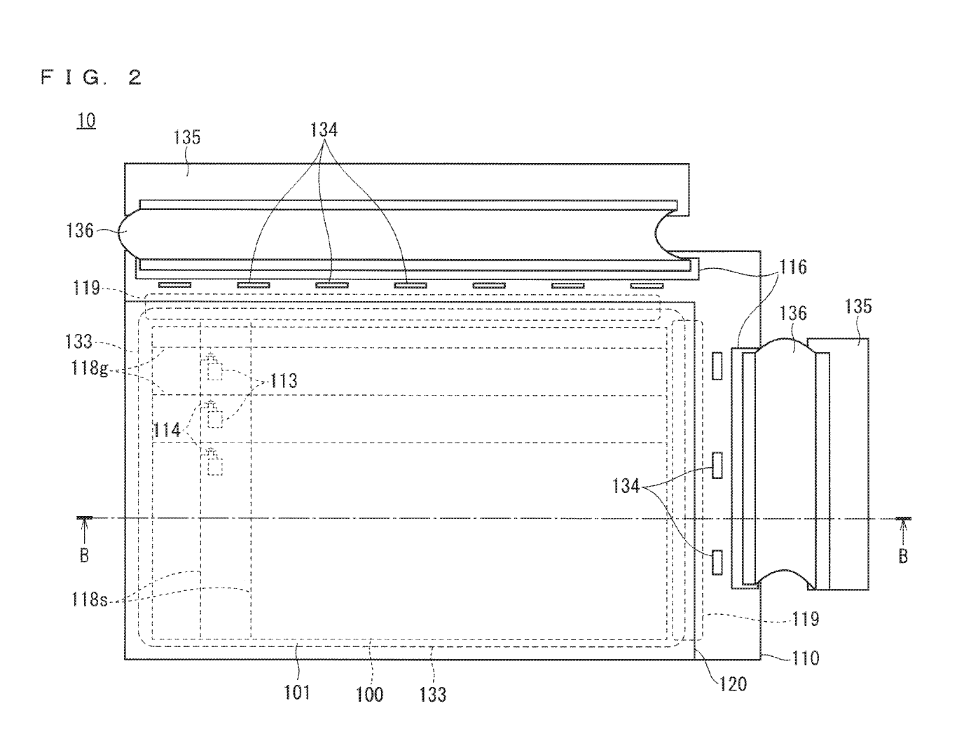

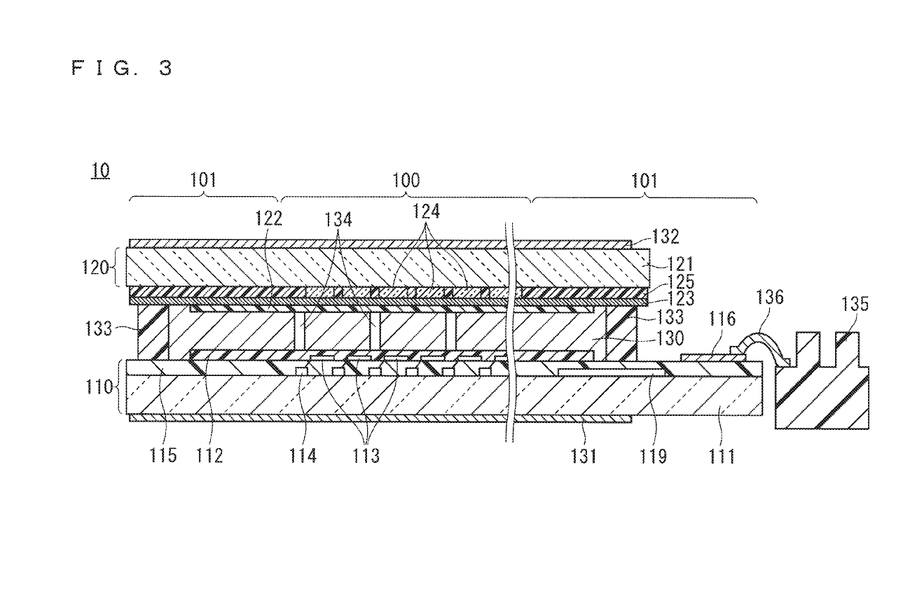

Subsequently, the specific configuration of the liquid crystal panel 10 that is a main part of the liquid crystal display device according to the preferred embodiment will be described with reference to FIGS. 2 and 3. FIG. 2 is a plan view of the liquid crystal panel 10 of the liquid crystal display device, and FIG. 3 is a sectional view taken along a line B-B in FIG. 2. For avoiding complexity of the drawings, the parts other than the main part of the present invention are not illustrated, and the configuration is partially simplified, as necessary. In the description herein, as one example, the present invention is applied to the liquid crystal panel 10 in which the operating mode of the liquid crystal is TN (Twisted Nematic) mode, and a thin-film transistor (TFT) is used as a switching element, however, the present invention may also be applied to an operating mode of the other liquid crystal or a liquid crystal panel provided with the other switching element. Note that the manufacturing method of the liquid crystal panel 10 will be described below in detail.

The liquid crystal panel 10 includes the TFT array substrate 110 serving as an array substrate in which switching elements such as TFT and pixel electrodes are arranged in an array, and the CF substrate 120 serving as a counter substrate mounted opposite to the TFT array substrate 110. The liquid crystal panel 10 is manufactured with one drop filling (ODF) method. With the ODF method, liquid crystal is disposed on the surface of either of the pair of substrates, i.e., either of the TFT array substrate 110 or the CF substrate 120, in the form of droplets, and then, is sandwiched between both substrates. With this, the liquid crystal is sealed and formed in the region enclosed by the sealing pattern 133.

Accordingly, as illustrated in the figures, the sealing pattern 133 is structurally characterized in that it has a closed loop shape, and neither has an injection port that is an opening from which liquid crystal is injected nor a sealing member for sealing the injection port as in a liquid crystal panel manufactured with a vacuum injection method.

Notably, in FIG. 2, the CF substrate 120 is illustrated only at an upper-left part in FIG. 2. In the other parts, the CF substrate 120 is not illustrated, and the configuration of the TFT array substrate 110 is illustrated, in order to illustrate the configuration of the TFT array substrate 110 arranged under the CF substrate 120. In the actual configuration, the CF substrate 120 is provided also at the outside of the region enclosed by the sealing pattern 133.

A frame region 101 is arranged to enclose the outside of the display region 100 in a form of a frame. In FIG. 2, a rectangular region serving as the display region 100 is specified as a boundary with the frame region 101. The display region 100 and the frame region 101 used herein are used for the portion on the TFT array substrate 110, the portion on the CF substrate 120, or the entire region sandwiched between both substrates in the liquid crystal panel 10, and they are used in the same meaning throughout the present specification.

The TFT array substrate 110 includes an orientation film 112 formed on one surface of a glass substrate 111 that is a transparent substrate for orienting the liquid crystal; pixel electrodes 113 mounted below the orientation film 112 for applying voltage to drive the liquid crystal; TFTs 114 that are switching elements for supplying voltage to the pixel electrodes 113; an insulating film 115 covering the TFTs 114; a plurality of gate lines 118g and source lines 118s which are lines for supplying signals to the TFTs 114; terminals 116 externally receiving the signals supplied to the TFTs 114; a transfer electrode (not illustrated) for transmitting the signals inputted from the terminals 116 to the CF substrate 120 side; and peripheral lines (not illustrated) for transmitting the signals inputted from the terminals 116 to the gate lines 118g, the source lines 118s, and the transfer electrode.

The TFT 114 is provided near the crossing portion of each of the gate lines 118g and each of the source lines 118s on the display region 100 on the TFT array substrate 110, the gate lines 118g and the source lines 118s being vertically and horizontally provided. The pixel electrode 113 is provided in each pixel region enclosed by the gate line 118g and the source line 118s, and the pixel electrodes 113 are arranged in a matrix. The terminals 116, the transfer electrode, and the peripheral lines are formed on the frame region 101. A polarizing plate 131 is formed on the other surface of the glass substrate 111.

On the other hand, the CF substrate 120 includes an orientation film 122 formed on one surface of a glass substrate 121 that is a transparent substrate for orienting the liquid crystal; a common electrode 123 provided below the orientation film 122 for generating an electric field with the pixel electrodes 113 on the TFT array substrate 110 to drive the liquid crystal; color filters 124 formed below the common electrode 123; and a black matrix (BM) 125 serving as a light shielding layer for shielding between the color filters 124 from light or for shielding the frame region 101 disposed at the outside of the region corresponding to the display region 100 from light. A polarizing plate 132 is formed on the other surface of the glass substrate 121 on the CF substrate 120, i.e., on the surface opposite to the surface on which the color filters 124, the black matrix 125, and the like are formed.

The TFT array substrate 110 and the CF substrate 120 are bonded to each other with the sealing pattern 133. The space between the TFT array substrate 110 and the CF substrate 120 is kept to be a predetermined distance, i.e., kept constant, with the columnar spacers 134 arranged in the display region 100. Notably, a dual spacer structure in which two different types of columnar spacers are formed may be employed. With the dual spacer structure, for example, some of the columnar spacers are relatively long, and specified as spacers (referred to as main spacers) for holding the space between the substrates as being in contact with the opposing substrate even in the normal state. The other columnar spacers are relatively short, and are specified as spacers (referred to as sub-spacers) that are not in contact with the opposing substrate and does not contribute to the holding of the space between the substrates in the normal state, but are in contact with the opposing substrate to hold the space between the substrates only when the distance between the substrates is reduced with external force.

A liquid crystal layer 130 is held in at least the region, which corresponds to the display region 100, in the space between the CF substrate 120 and the TFT array substrate 110 sealed by the sealing pattern 133 and held by the columnar spacers 134.

The configurations of the sealing pattern 133 and its formation region have the characteristic structure according to the present invention. As stated previously, the sealing pattern 133 is made of a photo-curable sealing material (photo-curable resin) containing about 1 wt % of resin bead-like spacers (SP-2035 manufactured by Sekisui Chemical Co., Ltd.) 144 with a diameter of 3.5 micrometers (the diameter when pressure is not inputted) as the spacer-in-sealing, for example. In addition, the columnar spacers 134 are formed on the formation region of the sealing pattern 133 so as to project from the CF substrate 120 side. Each of the columnar spacers 134 has a length shorter than the diameter of the spacer-in-sealing by the length corresponding to the predetermined deformation amount (deformation allowable amount of the spacer-in-sealing, basically the maximum value within the elastic deformation), and also has the strength against deformation (elastic constant) higher than the spacer-in-sealing. The columnar spacers 134 formed on the formation region of the sealing pattern 133 may project from the TFT array substrate 110. However, it is desirable that the columnar spacers 134 are formed on the substrate on which the columnar spacers 134 disposed in the display region 100 are formed. With this, the columnar spacers can be formed with the same manufacturing process.

The transfer electrode and the common electrode 123 respectively formed on the TFT array substrate 110 and the CF substrate 120 are electrically connected to each other with a transfer material which is formed between these substrates and made of resin containing conductive particles. The signals inputted from the terminals 116 are transmitted to the common electrode 123. Elastically deformable particles are preferable for the conductive particles in light of stabilization of conduction. For example, spherical resin to which gold plating is performed on its surface is preferably used. When the operating mode of the liquid crystal is not a TN mode, but a transverse electric mode, the common electrode 123 is not formed on the CF substrate 120. Therefore, the transfer electrode and the transfer material for transmitting signals to the common electrode 123 are eliminated.

A control board 135 is connected to each pad of the terminals 116. The control board 135 is provided with a control IC (Integrated Circuit) chip for generating a control signal for controlling a drive IC chip through FFC (Flexible Flat Cable) 136 serving as a connection line, and the like. The control signal from the control board 135 is inputted to an input side of the drive IC chip mounted to the projecting portion through the control terminals 116, and the output signal outputted from the output side of the drive IC chip is supplied to the TFTs 114 in the display region 100 through a lot of signal extraction lines (not illustrated) extended from the display region 100.

A testing circuit 119, which allows the liquid crystal panel 10 to perform a display operation during the manufacturing process of the liquid crystal panel 10, especially before the control board 135 is mounted, is provided on the side of the liquid crystal panel 10 where the control board 135 and the terminals 116 are disposed.

A backlight unit (not illustrated) serving as a light source is provided to be opposite to the TFT array substrate 110 located at the opposite side of the display surface of the liquid crystal panel 10. An optical sheet (not illustrated) for controlling polarizing state and directionality of light is provided between the liquid crystal panel 10 and the backlight unit. The liquid crystal panel 10 is stored in a housing (not illustrated) together with these components, the housing being open at the portion outside the CF substrate 120 in the display region 100 serving as the display surface. Thus, the liquid crystal display device according to the present preferred embodiment is configured.

The liquid crystal display device described above according to the present preferred embodiment operates as stated below. For example, a control signal is inputted from the control board 135 to activate the drive IC chip, and the signal is transmitted to the pixel regions through the wiring lines in the display region 100. This results in applying predetermined drive voltage between the pixel electrode 113 arranged in each pixel region and the common electrode 123 arranged on the CF substrate 120, and the orientation of liquid crystal molecules is changed according to the drive voltage. Then, light emitted from the backlight unit is transmitted toward an observer through the TFT array substrate 110, the liquid crystal layer 130, and the CF substrate 120, or shielded, whereby an image is displayed on the display surface formed in the display region 100 on the side of the CF substrate 120 of the liquid crystal panel 10.

When void-in-sealing is generated in the sealing pattern 133, for example, the adhesive force and moisture resistance (environment resistance) of the sealing pattern 133 are deteriorated. This disables the normal operation described above to cause a display failure. However, the liquid crystal display device according to the present preferred embodiment suppresses the occurrence of the void-in-sealing, thereby being capable of being manufactured with excellent yield without causing the display failure described above.

(Manufacturing Flow of Liquid Crystal Panel)

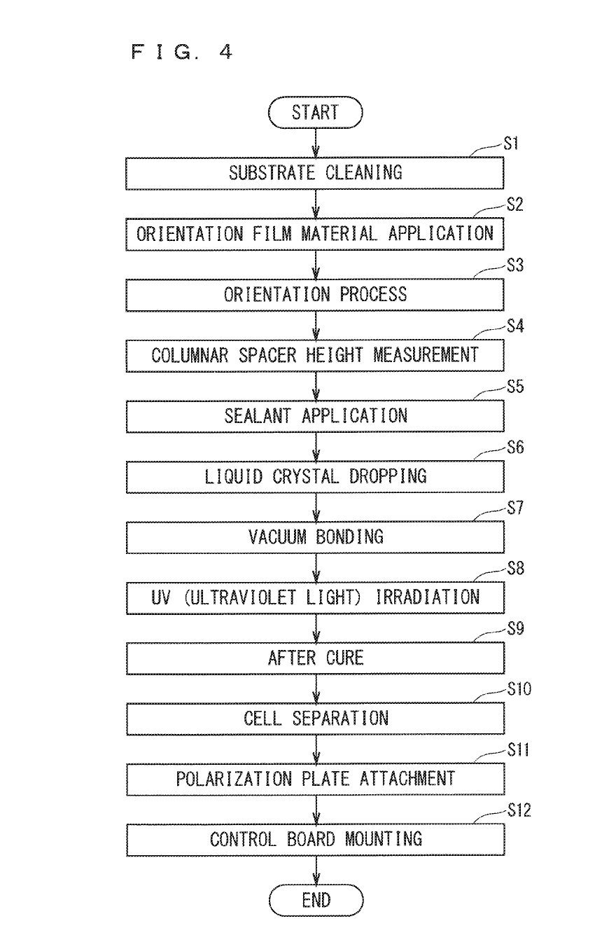

Next, the overall flow of the manufacturing method of the liquid crystal panel 10 in the liquid crystal display device will be described. The outline of the manufacturing process of the liquid crystal panel 10 will be described with reference to the flowchart in FIG. 4. FIG. 4 is a flowchart illustrating the manufacturing process of the liquid crystal panel 10. The liquid crystal panel 10 which is the main part of the liquid crystal display device is manufactured such that one or more (multiple formation) liquid crystal panels 10 are cut out from a mother board larger than the final shape. The processes from step S1 to step S9 and the process in the middle of step S10 are the processes for the mother board.

In a substrate preparation step, the TFT array substrate 110 and the CF substrate 120 are prepared in the form of the mother board. A general method may be used for manufacturing the TFT array substrate 110 and the CF substrate 120. Therefore, the method will briefly be described. The TFT array substrate 110 is manufactured such that TFTs 114, pixel electrodes 113, terminals 116, and transfer electrode 117 are formed on one surface of the glass substrate 111 by repeatedly performing film formation, patterning with the photolithography process, and pattern formation process such as etching.

The CF substrate 120 is similarly manufactured such that the color filters 124, the black matrix 125, the common electrode 123, and the columnar spacers 134 formed by patterning an organic resin film are formed on one surface of the glass substrate 121. When the columnar spacers 134 are formed to have a dual spacer structure in which two different types of columnar spacers are formed, a photolitho process utilizing a known halftone technique that is a formation method of a dual spacer structure may be used to form different lengths.

As for the columnar spacers 134 formed on the formation region of the sealing pattern 133 so as to project from the CF substrate 120 side, when the columnar spacers 134 are formed by patterning an organic resin film, the known halftone technique that is the formation process of the dual spacer structure is utilized to differ the length of the columnar spacers 134 and the formation region. With this, the columnar spacers 134 can be formed with the same photolitho process as the columnar spacers 134 disposed in the display region 100 without additionally performing a new process. The columnar spacers 134 formed in the formation region of the sealing pattern 133 may obviously be provided separately from the columnar spacers 134 disposed in the display region 100. For example, when the color filters 124 are formed on the CF substrate 120, patterning in which the color filters 124 of different colors are superimposed may be performed. With this, the columnar spacers 134 can simultaneously be formed with the formation process of the color filters 124 without additionally performing a new process.

Next, in a substrate cleaning process in step S1, the TFT array substrate 110 on which the pixel electrodes 113 are formed is cleaned. Then, in the orientation film material application process in step S2 which is the characteristic part of the present invention, a material of an orientation film is applied on one surface of the TFT array substrate 110. Subsequently, the applied material of the orientation film is subjected to a burning process with a hot plate, and dried.

Thereafter, in an orientation process in step S3, an orientation process, such as a rubbing process, for forming fine grooves or scratches along a specific direction on the surface of the material of the orientation film is performed to the applied material of the orientation film. Thus, the orientation film 112 is formed. The orientation process performed to the orientation film 112 is not limited to the rubbing process. Any known orientation process such as a photo-alignment process may be used.

The case where the processes in steps S1 to S3 are performed to the TFT array substrate 110 has been described above. As for the CF substrate 120 on which the common electrode 123 is formed, the cleaning process in step S1 is performed, then, the material of the orientation film is applied in step S2, and the rubbing process is performed as the orientation process in step S3 in the similar manner. Thus, the orientation film 122 is formed. Specifically speaking, when the orientation film 122 is formed on the CF substrate 120, the columnar spacers 134 formed on the CF substrate 120 are also covered with the orientation film 122. However, the thickness of the orientation film 122 is smaller than the length of each columnar spacer 134, so that the orientation film applied on the columnar spacers 134 is not illustrated in the figures.

Next, in step S4, the length of each columnar spacer 134 is measured. In the present preferred embodiment, the columnar spacers 134 are formed on the CF substrate 120. Therefore, the initial length may be measured on the CF substrate 120. The meaning of measuring the length of each columnar spacer 134 in this process is to decide the dropping amount of the liquid crystal upon injecting the liquid crystal with the one drop filling (ODF) method. This will be described again later. Accordingly, the length of the columnar spacer 134 (the length of the main spacer in the dual spacer structure) for determining a cell gap involved with a capacity of a space filled with the liquid crystal is measured.

Then, in a sealant application process in step S5, a sealant is applied on the main surface of the TFT array substrate 110 or the CF substrate 120 as a printing paste with a screen printing device. The sealant contains bead-like spacers 144 made of elastically deformable resin as spacer-in-sealing. The sealant is applied to enclose the display region 100 of the liquid crystal panel 10, and forms the sealing pattern 133.

A sealant containing conductive particles may be applied on the sealing pattern 133 at a region where the transfer electrode on the TFT array substrate 110 and the common electrode 123 on the CF substrate 120 are superimposed. This configuration can provide a conduction function between the substrates. However, in the present preferred embodiment, the bead-like spacers 144 made of elastically deformable resin are formed in the sealing pattern 133 as the spacer-in-sealing. Therefore, the present preferred embodiment is configured such that the sealing pattern 133 does not have the conduction function between the substrates, the transfer electrode is separately mounted at the outside of the region enclosed by the sealing pattern 133, and a transfer material made of a resin paste containing conductive particles is applied on the region overlapped with the transfer electrode. The process of applying the transfer material on one surface of the TFT array substrate 110 or the CF substrate 120 may be performed after the process in step S5.

The resinous bead-like spacers 144 according to the present preferred embodiment may be changed to resinous bead-like spacers coated with gold to have a function as conductive particles. With this, the sealant containing resinous bead-like spacers coated with gold is used for the sealing pattern 133 as conductive particles, and this can provide the conduction function between the substrates as stated previously. In such case, it is unnecessary to separately apply the transfer material made of a resin paste containing conductive particles on the region overlapped with the transfer electrode as described above. Therefore, the manufacturing process can be reduced.

In the present preferred embodiment, columnar spacers 134 formed by patterning an organic resin film are used as spacers for holding the space between the substrates in a predetermined distance. However, spherical spacers may be distributed to form spacers for holding the space between the substrates in a predetermined distance. In this case, the spacer distributing process may be performed after the process in step S5, like the above transfer material application process.

Then, in a liquid crystal dropping process in step S6, liquid crystal is dropped in the region enclosed by the sealing pattern 133 on the substrate on which the sealing pattern 133 is formed. The dropping amount of the liquid crystal is decided based on the length of the columnar spacer 134 measured in step S4.

Next, in a vacuum bonding process in step S7, the TFT array substrate 110 and the CF substrate 120, which are in the form of a mother board, are bonded to each other in vacuum to form a mother cell board. In the present invention, especially in the vacuum bonding process, the characteristic structure of the sealing pattern 133 and its formation region according to the present invention effectively functions, even if local and temporal load is applied due to deposition of foreign matters or poor flatness of a stage. This can prevent the spacer-in-sealing from being deformed more than necessary (for example, exceeding the elastic deformation range), whereby void-in-sealing is not generated.

Next, in a UV (ultraviolet light) irradiation process in step S8, the mother cell board is irradiated with ultraviolet light to allow the sealant to be temporarily cured. Thereafter, in step S9, after cure is performed with a heat treatment, whereby the sealant is fully cured. Thus, the cured sealing pattern 133 is obtained.

Then, in a cell separation process in step S10, the mother cell board is cut along a scribed line to be separated into individual liquid crystal panels.

A polarizing plate attaching process in step S11, a control board mounting process in step S12, and the like are executed to the separated individual liquid crystal panel. Thus, a series of the manufacturing process is finished, and the liquid crystal panel 10 is completed.

Then, a backlight unit is disposed on the back surface of the TFT array substrate 110 which is the side opposite to the viewing side of the liquid crystal panel 10 through an optical film such as a phase difference plate, and the liquid crystal panel 10 and the peripheral components are appropriately stored in a frame made of resin or metal. Thus, a final liquid crystal display device according to the present preferred embodiment is completed.

In the preferred embodiment, the columnar spacers 134 formed on the CF substrate 120 or the TFT array substrate 110 with a photolitho process are formed as the spacers formed in the formation region of the sealing pattern 133 for preventing the spacer-in-sealing from being deformed beyond the predetermined deformation amount. When the columnar spacers 134 formed with the photolitho process are employed, the arrangement in the formation region of the sealing pattern 133, i.e., the array, the space between the columnar spacers 134, and the density, can more correctly be set. Specifically, the columnar spacers 134 can be functioned more appropriately according to the strength characteristics of the spacer-in-sealing and an application of external force expected in the vacuum bonding process in step S7. Accordingly, it is more desirable.

However, the spacers arranged in the formation region in the sealing pattern 133 are not limited to the columnar spacers formed with the photolitho process. A spacer with any other shape can be employed, so long as it has a length shorter than the diameter of the spacer-in-sealing by the length corresponding to the predetermined deformation amount, has a strength against deformation (elastic constant) higher than the spacer-in-sealing, and functions to prevent the spacer-in-sealing from being deformed beyond the predetermined deformation amount.

For example, the spacer may be a spherical spacer or cylindrical rod-like spacer (micro rod) present in the sealing pattern 133 like the spacer-in-sealing. A spacer made of relatively hard material, such as glass or resin that is difficult to be deformed, and having the above shapes may be used. In the case of a spherical spacer, the diameter of the sphere may be set as the above predetermined length of the spacer, and in the case of a rod-like spacer, the diameter of the circle of the cylinder may be set as the above predetermined length of the spacer. When a hard material such as micro rod is contained as the spacer-in-sealing, the wiring lines of the TFT substrate are likely to be damaged in general. However, when a spherical spacer or a cylindrical rod-like spacer with a length shorter than the diameter of the spacer-in-sealing is used, the wiring lines are hardly damaged. Therefore, the above spacers can be used as the spacer according to the present invention.

With regard to the relationship of the strength against deformation between the first and second spacer, the same material may be used as the bead-like spacer and the columnar space, for example, to equalize the strength against deformation between the first spacer (bead-like spacer) and the second spacer (columnar spacer).

As described above, the liquid crystal display device according to the preferred embodiment includes the TFT array substrate 110, the CF substrate 120 arranged at the position opposite to the TFT array substrate 110, the sealing pattern 133 that seals liquid crystal held between the TFT array substrate 110 and the CF substrate 120, the bead-like spacers 144 which are arranged in the sealing pattern 133 and elastically deformable, and columnar spacers 134 arranged in the sealing pattern 133 and having the strength against deformation higher than the bead-like spacers 144, wherein each of the columnar spacers 134 is formed to have a length shorter than the bead-like spacer 144 in the thickness direction of the liquid crystal.

When a load is locally applied upon bonding the TFT array substrate 110 and the CF substrate 120 to each other, the bead-like spacers 144 are elastically deformed. However, the load can be supported by the columnar spacers 134 having the higher strength against deformation than the bead-like spacers 144, whereby the distance between the TFT array substrate 110 and the CF substrate 120 can be maintained. Accordingly, the sealing pattern 133 is not excessively crushed, which can prevent the generation of void in the sealing and excessive increase in the width of the sealing pattern 133. With this, yield of the liquid crystal display device can be enhanced.

The difference in length in the thickness direction of the liquid crystal between the bead-like spacer 144 and the columnar spacer 134 is set to be equal to or lower than 15% of the diameter of the bead-like spacer. Therefore, the specific range by which the void in the sealing is surely prevented can be obtained based on the diameter of the bead-like spacer 144.

The columnar spacer 134 formed by patterning is used as a second spacer which has the strength against deformation and is arranged in the sealing pattern 133. With this, arrangement density and uniformity can correctly be controlled, and the generation of the void in the sealing throughout the sealing pattern 133 can more surely be prevented.

The area density of the columnar spacers 134 to the area of the sealing pattern 133 in a plan view is set to be equal to or larger than 1% and less than 50%. Therefore, the columnar spacers 134 in the sealing pattern 133 can support a predetermined load with little deformation. With this, the deformation of the sealing pattern 133 beyond the range in which the void in the sealing is not generated can more surely be prevented.

The preferred embodiment of the present invention can be modified or omitted within the scope of the invention, as necessary.

While the invention has been shown and described in detail, the foregoing description is in all aspects illustrative and not restrictive. It is therefore understood that numerous modifications and variations can be devised without departing from the scope of the invention.

What is claimed is:

1. A liquid crystal display device comprising:
a first substrate;
a second substrate arranged at the position opposite to said first substrate via a liquid crystal layer;
a sealing pattern that seals liquid crystal held between said first and second substrates;
a first spacer that is arranged in said sealing pattern and elastically deformable; and
a second spacer arranged in said sealing pattern and formed to have a length shorter than said first spacer in the thickness direction of said liquid crystal layer.

2. The liquid crystal display device according to claim 1, wherein said first spacer has a bead-like shape.

3. The liquid crystal display device according to claim 1, wherein said second spacer has a strength against deformation higher than said first spacer.

4. The liquid crystal display device according to claim 2, wherein a difference in length in the thickness direction of said liquid crystal between said first spacer and said second spacer is set to be equal to or lower than 15% of a diameter of said first spacer having a bead-like shape.

5. The liquid crystal display device according to claim 1, wherein said second spacer is a columnar spacer.

6. The liquid crystal display device according to claim 5, wherein an area density of said columnar spacer to an area of said sealing pattern in a plan view is set to be equal to or larger than 1% and less than 50%.

7. A manufacturing method of a liquid crystal display device in which a liquid crystal is sealed in a sealing pattern, which includes a first spacer, and a first substrate is arranged at a position opposite to a second substrate via a liquid crystal layer, the manufacturing method comprising:
a second spacer forming process to form a second spacer in a sealing pattern forming region of said first or second substrate;
a liquid crystal dropping process to form a sealing pattern including said first spacer that is elastically deformable in said sealing pattern forming region of said second substrate, and afterwards, drop a liquid crystal in said sealing pattern so that a length of said first spacer in a thickness direction of said liquid crystal layer is formed to be longer than a length from a substrate surface in said second spacer; and
a process, after said second spacer forming process and said crystal dropping process, to overlap said first and second substrates and then curing a sealing pattern including said first and second spacers while keeping said first and second substrates overlapped.

8. The manufacturing method of the liquid crystal display device according to claim 7, wherein said second spacer is formed by patterning.

9. The manufacturing method of the liquid crystal display device according to claim 7, wherein after said process to curing said sealing pattern, said second spacer has a length shorter than said first spacer in a thickness direction of said liquid crystal layer.

10. The manufacturing method of the liquid crystal display device according to claim 7, wherein said first spacer is formed to have a bead-like shape.

11. The manufacturing method of the liquid crystal display device according to claim 7, wherein said second spacer is formed to have a strength against deformation higher than said first spacer.

12. The manufacturing method of the liquid crystal display device according to claim 10, wherein a difference in length in the thickness direction of said liquid crystal between said first spacer and said second spacer is set to be equal to or lower than 15% of a diameter of said first spacer having a bead-like shape.

13. The manufacturing method of the liquid crystal display device according to claim 7, wherein said second spacer is a columnar spacer.

14. The manufacturing method of the liquid crystal display device according to claim 13, wherein an area density of said columnar spacer to an area of said sealing pattern in a plan view is set to be equal to or larger than 1% and less than 50%.
